(19) United States
(12) Patent Application Publication
(10) Pub. No.: US 2023/0143883 A1
(43) Pub. Date: May 11, 2023

(54) Dynamic Control of Audio

(71) Applicant: Citrix Systems, Inc., Fort Lauderdale, FL (US)

(72) Inventors: Yuan Bai, Nanjing (CN); Mingming Ren, Nanjing (CN); Yajun Yao, Nanjing (CN); Zhaohui Mei, Nanjing (CN)

(21) Appl. No.: 17/538,432

(22) Filed: Nov. 30, 2021

Related U.S. Application Data
(63) Continuation of application No. PCT/CN2021/129903, filed on Nov. 10, 2021.

(51) Int. Cl. G10L 25/60; G10L 21/0332; H04L 65/80; H04L 65/60

(52) U.S. Cl. CPC G10L 25/60; G10L 21/0332; H04L 65/80; H04L 65/60

(57) ABSTRACT

Methods and systems for controlling audio quality of a real-time communication are provided. A system may receive first and second data from a first endpoint device, the first and second data being audible input from a same user, the first data satisfies a threshold indicative of a level of quality in output of audio data by a second endpoint device, and the second data being input for a computing session between the first endpoint device and a plurality of devices including the second endpoint device, compare the first and second data to one another to determine whether the second data satisfies the threshold, responsive to a failure of the second data to meet the threshold, modify the second data, and provide the modified second data to the second endpoint device, wherein the second endpoint device outputs the modified second data at the level of quality.

### CROSS REFERENCE TO RELATED CASE

This application is a continuation of and claims priority to co-pending PCT Application No. PCT/CN21/129903, filed on Nov. 10, 2021, which is titled “DYNAMIC CONTROL OF AUDIO,” which is incorporated herein by reference in its entirety for all purposes.

### FIELD

Aspects described herein generally relate to data processing, hardware, and software related thereto. More specifically, one or more aspects described herein relate to controlling playback of audio data on computing devices.

### BACKGROUND

Computing devices regularly send audio data over computer networks. Audio data is typically digitized and encoded before being sent to another device or user. In some applications, e.g., VOIP, web meetings, etc., it is important for audio data to be transmitted in real-time. To do so, applications may monitor current network characteristics, and send the audio data using the best possible quality based on those characteristics such that it will still be delivered in real-time. However, when network conditions are sub-optimal or poor, the audio data might be sent in a lower quality than is otherwise preferred.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

Audio quality may suffer during a real-time communication over a network due to various factors. The various factors, for example, may include background noise (e.g., airport, park, market) of an environment, as well as poor conditions of the network (e.g., noises due to signal interferences). For example, a user may rely on a client device to remotely attend meetings using various conferencing applications (e.g., Microsoft Teams, Zoom, Webex, GoToMeeting, Skype, etc.), from a home, office, park, market, or airport, etc. The audio data processed by the client device may suffer from poor audio quality (e.g., noises, irregular audio volumes, etc.) caused by the background noises and/or unstable network conditions. Yet the user of the client device, exposed to these various factors, might not even be aware of the poor audio quality of the audio data that another user may receive from the client device.

To overcome limitations described above, and to overcome other limitations that will be apparent upon reading and understanding the present specification, aspects described herein are directed towards controlling audio quality of real-time communications.

In accordance with one or more embodiments of the disclosure, a method may include sampling a first audio that satisfies criteria (e.g., predetermined criteria), extracting audio characteristics from the sampled first audio and saving the extracted audio characteristics, establishing a communication channel over a network, monitoring a second audio streaming over the communication channel, adjusting the second audio based on the extracted audio characteristics, and outputting the adjusted second audio.

In one or more instances, predetermined criteria may include that a first signal-to-noise ratio of the first audio is greater than a second signal-to-noise ratio of the second audio, a third signal-to-noise ratio of the adjusted second audio is closer to the first signal-to-noise ratio than the second signal-to-noise ratio.

In one or more instances, the method may further include calculating an average value of one of audio characteristics of the second audio for a period of time that the second audio is monitored, and determining whether the average value satisfies a target threshold derived from the predetermined criteria.

In one or more instances, the method may further include extracting at least one of a volume range, a bandwidth, a pitch, and a pitch-range from the audio characteristics of the sampled first audio.

In one or more instances, the adjusting the second audio may include changing at least one of a volume range, a bandwidth, a pitch, and a pitch-range of the second audio.

In one or more instances, the adjusting the second audio may include changing an amplitude of a waveform of the second audio to match a volume range of the second audio with a volume range of the sampled first audio.

In one or more instances, the adjusting the second audio may include comparing at least one of a volume range, a bandwidth, a pitch, and/or a pitch-range of the second audio against the at least one of the sampled first audio.

In one or more instances, the outputting the adjusted second audio may include feeding the adjusted second audio in real-time via a client device or a server that is providing an online communication application.

In one or more instances, a first voice in the first audio and a second voice in the second audio are from the same source.

In one or more instances, the method may further include saving the sampled first audio as part of a client profile in a workspace or in a cloud storage.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIG. 5 shows an example of a communications environment.

FIG. 6 shows an example of voice waveforms.

FIG. 7 shows an example of message sequences for audio service.

FIG. 8 shows an example of alternative message sequences for audio service.

FIG. 9 shows an example of voice waveforms before and after audio service.

FIG. 10 shows an example of sampling audio data process.

FIG. 11 shows an example of audio service process.

FIG. 12 shows an example of adjusting or updating process.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards controlling audio quality during communications (e.g., a real-time communication) based on a profile (e.g., user profile that is prepared in advance). Audio data of the user, satisfying a threshold (e.g., a quality level), may be recorded, sampled, or saved into the user profile. Later, during a real-time communication, a live stream of audio data may be monitored and adjusted for satisfying criteria for a target (e.g., quality criteria set in advance based on the user profile). As a result, a terminal or other endpoint device may receive the adjusted live stream of audio data that meets the target quality criteria.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect connecting and coupling,

Computing Architecture

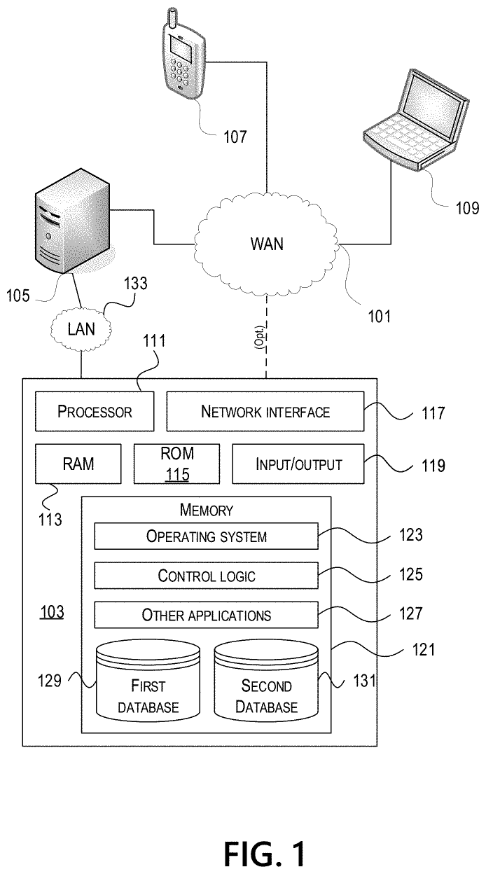

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

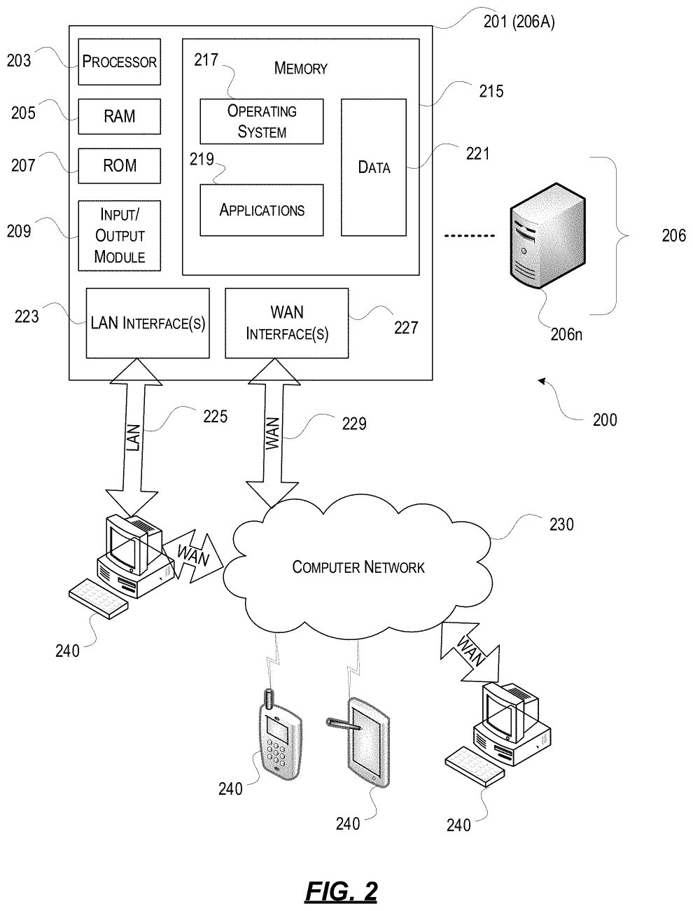

With further reference to FIG. 2, one or more aspects described herein may be implemented in a remote-access environment. FIG. 2 depicts an example system architecture including a computing device 201 in an illustrative computing environment 200 that may be used according to one or more illustrative aspects described herein. Computing device 201 may be used as a server 206a in a single-server or multi-server desktop virtualization system (e.g., a remote access or cloud system) and can be configured to provide virtual machines for client access devices. The computing device 201 may have a processor 203 for controlling overall operation of the device 201 and its associated components, including RAM 205, ROM 207, Input/Output (I/O) module 209, and memory 215.

I/O module 209 may include a mouse, keypad, touch screen, scanner, optical reader, and/or stylus (or other input device(s)) through which a user of computing device 201 may provide input, and may also include one or more of a speaker for providing audio output and one or more of a video display device for providing textual, audiovisual, and/or graphical output. Software may be stored within memory 215 and/or other storage to provide instructions to processor 203 for configuring computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, such as terminals 240 (also referred to as client devices and/or client machines). The terminals 240 may be personal computers, mobile devices, laptop computers, tablets, or servers that include many or all of the elements described above with respect to the computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem or other wide area network interface 227 for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, personal digital assistants (PDAs), notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network personal computers (PCs), minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in other aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. The server farm 206 may include servers 206 that are geographically dispersed while logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a Secure Sockets Layer (SSL) VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b (not shown), and responds to the request generated by the client machine 240 with a response from the second server 206b (not shown.) First server 206a may acquire an enumeration of applications available to the client machine 240 as well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

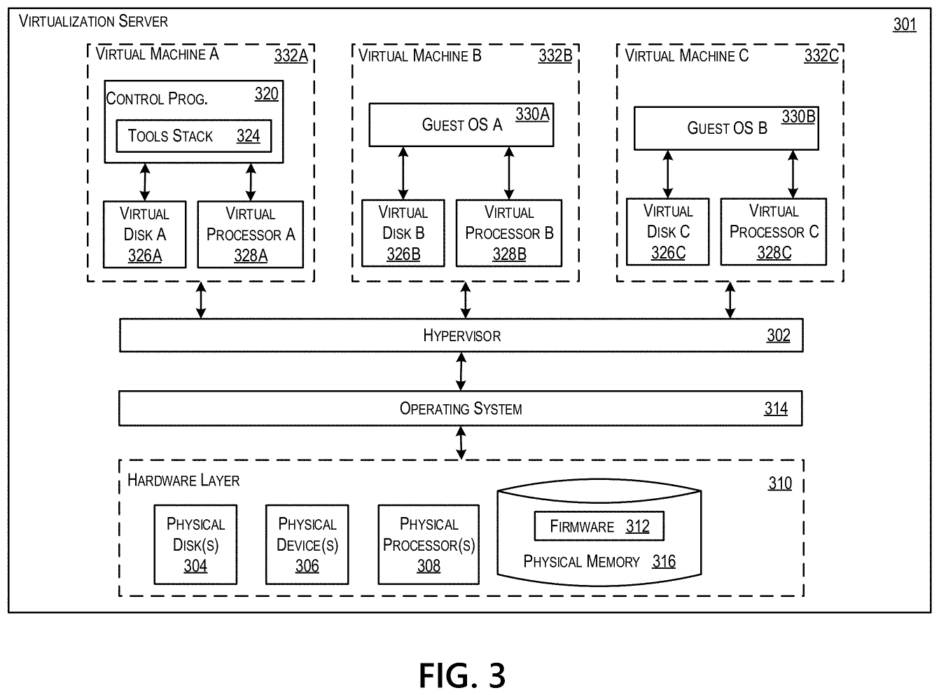

FIG. 3 shows a high-level architecture of an illustrative desktop virtualization system. As shown, the desktop virtualization system may be single-server or multi-server system, or cloud system, including at least one virtualization server 301 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e g, many instances of an OS running on a single device). Each application may be executed on a local device, or executed on a remotely located device (e.g., remoted).

A computer device 301 may be configured as a virtualization server in a virtualization environment, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308, and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and one or more physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor executes within an operating system 314 executing on the virtualization server 301. Virtual machines may then execute at a level above the hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316, and any other component included in hardware layer 310 of the virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for a virtual machine 332 executing on virtualization server 301. Hypervisor 302 may include those manufactured by VMWare, Inc., of Palo Alto, Calif.; HyperV, VirtualServer or virtual PC hypervisors provided by Microsoft, or others. In some embodiments, virtualization server 301 may execute a hypervisor 302 that creates a virtual machine platform on which guest operating systems may execute. In these embodiments, the virtualization server 301 may be referred to as a host server. An example of such a virtualization server is the Citrix Hypervisor provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating system 330.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, may imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, may provide each virtual machine 332 with a unique virtual view of the physical hardware, memory, processor, and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided, and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided, and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

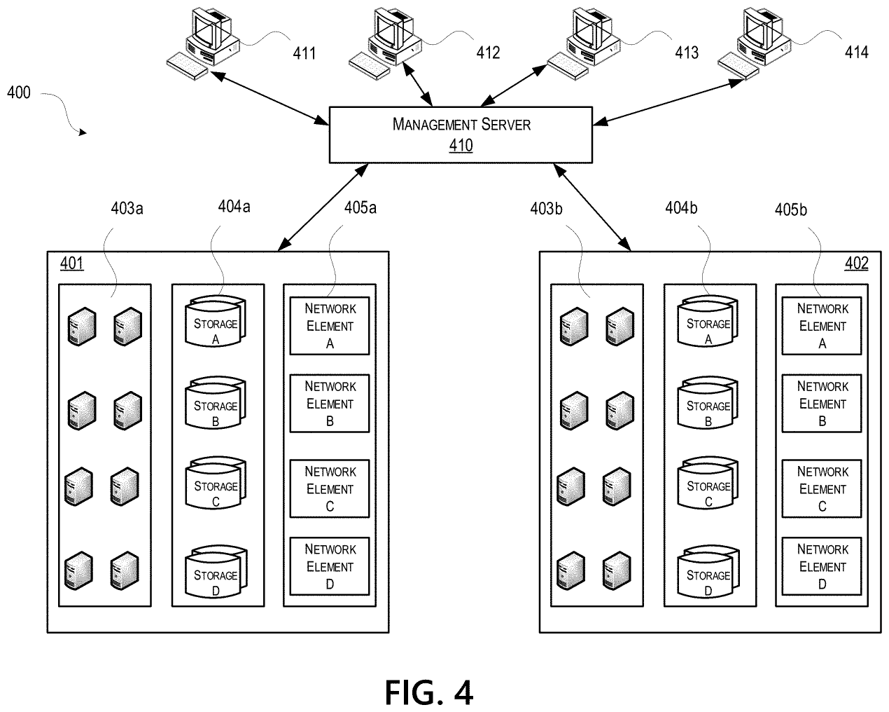

With further reference to FIG. 4, some aspects described herein may be implemented in a cloud-based environment. FIG. 4 illustrates an example of a cloud computing environment (or cloud system) 400. As seen in FIG. 4, client computers 411-414 may communicate with a cloud management server 410 to access the computing resources (e.g., host servers 403a-403b (generally referred herein as “host servers 403”), storage resources 404a-404b (generally referred herein as “storage resources 404”), and network elements 405a-405b (generally referred herein as “network resources 405”)) of the cloud system.

Management server 410 may be implemented on one or more physical servers. The management server 410 may run, for example, Citrix Cloud by Citrix Systems, Inc. of Ft. Lauderdale, Fla., or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-414 and/or over a private network. In other embodiments, public clouds or hybrid public-private clouds may be used by other customers over an open or hybrid networks.

Management server 410 may be configured to provide user interfaces through which cloud operators and cloud customers may interact with the cloud system 400. For example, the management server 410 may provide a set of application programming interfaces (APIs) and/or one or more cloud operator console applications (e.g., web-based or standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via client computers 411-414, for example, requests to create, modify, or destroy virtual machines within the cloud. Client computers 411-414 may connect to management server 410 via the Internet or some other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at client computers 411-414, over a network (e.g., the Internet), providing customers with computational resources, data storage services, networking capabilities, and computer platform and application support. Cloud systems also may be configured to provide various specific services, including security systems, development environments, user interfaces, and the like.

Certain clients 411-414 may be related, for example, to different client computers creating virtual machines on behalf of the same end user, or different users affiliated with the same company or organization. In other examples, certain clients 411-414 may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management server 410 may be located at one of the availability zones, or at a separate location. Each zone may include an internal network that interfaces with devices that are outside of the zone, such as the management server 410, through a gateway. End users of the cloud (e.g., clients 411-414) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zone 401-402 may include one or more computer servers 403, such as the virtualization servers 301 described above, which may be configured to create and host virtual machine instances. The physical network resources in a cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as shown in FIGS. 1-3) with additional hardware and/or software resources configured to create and manage virtual machines and provide other services to customers using the physical resources in the cloud. The virtualization layer may include hypervisors, as described above in FIG. 3, along with other components to provide network virtualizations, storage virtualizations, etc. The virtualization layer may be as a separate layer from the physical resource layer, or may share some or all of the same hardware and/or software resources with the physical resource layer. For example, the virtualization layer may include a hypervisor installed in each of the virtualization servers 403 with the physical computing resources. Known cloud systems may alternatively be used, e.g., WINDOWS AZURE (Microsoft Corporation of Redmond Wash.), AMAZON EC2 (Amazon.com Inc. of Seattle, Wash.), IBM BLUE CLOUD (IBM Corporation of Armonk, N.Y.), or others.

Controlling Audio Quality During Real-Time Communication Based on a User Profile

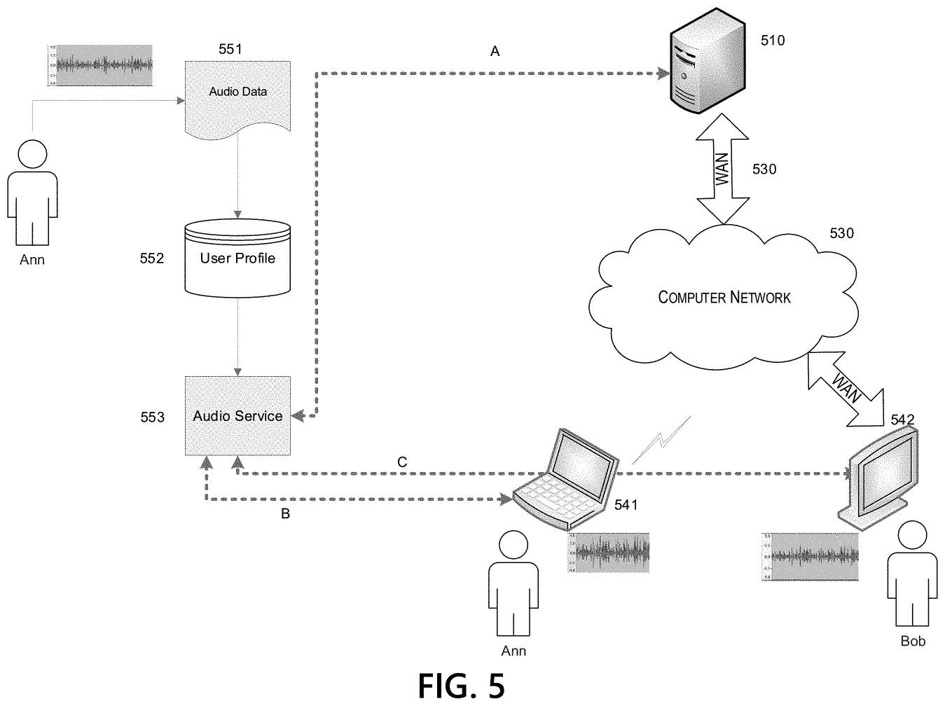

FIG. 5 shows an example of a computing environment. A communication channel may be established between terminals 541 and 542. Audio service 553 may control audio data during a real-time communication over the communication channel. For example, the audio service may enhance quality of the audio data (e.g., filtering out noises, regulating a voice volume in the audio data, etc.) received by the terminal 541 so that the terminal 541 may receive the audio data with the enhanced quality.

Prior to establishing the communication channel, data 551 (e.g., audio data) of at least one of the parties (e.g., Ann) involved may be sampled or recorded and saved into a profile of a database (e.g., user profile 552), provided that audio data 551 satisfies criteria (e.g., predetermined criteria). For example, one criterion may be that a signal-to-noise ratio of audio data 551 satisfies a threshold or level. For example, Ann's voice may be recorded without a background noise to satisfy the threshold level (e.g., a noise level). Audio data 551 containing Ann's voice may be saved into user profile 552.

Computing device 510 may be used as a server in a single-server or multi-server desktop virtualization system (e.g., a remote access or cloud system) and can be configured to provide virtual machines for client access devices. Computing device 510 may include a modem or other wide area network interface for establishing communications over the WAN 530, such as computer network 530 (e.g., the Internet). Computing device 510 may operate in a networked environment establishing a communication channel across remote computers, such as terminals 541 and 542. For example, computing device 510 may establish a video and/or an audio conferencing between terminals 541 and 542, for example, using an online communication application (e.g., Microsoft Teams, Zoom, Webex, GoToMeeting, Skype, etc.). The terminals 541 and 542 may be personal computers and/or mobile terminals (e.g., mobile phones, smartphones, personal digital assistants, notebooks, laptop computers, tablets, monitors, or servers, etc.). The terminals 541 and 542 may be interconnected with each other wirelessly or via wired lines.

During the real-time communication over the communication channel (e.g., Microsoft Teams), Bob may experience trouble hearing Ann's voice via terminal 542. For example, terminal 541 may be in an environment exposed to a background noise (e.g., airport, park, market, unstable network conditions, etc.). Audio service 553 may dynamically interact with the communication channel to prevent or resolve the trouble. Audio service 553 may control audio quality during the real-time communication based on user profile 552. Audio service 553 may monitor a live stream of audio data (e.g., Ann's voice with a background noise) over the communication channel for a period of time. Audio service 553 may determine that one or more audio characteristics of the audio data fail to satisfy target criteria (e.g., a preset range of voice volumes, a preset range of voice frequencies). Audio service 553 may determine the failure based on accrued calculations or measurements made over the period of time T (e.g., 1 min. ≤T≤5 min) Audio service 553 may adjust or update the live stream of audio data, for example, by modifying the one or more audio characteristics to boost the audio quality of the live stream of audio data. For example, an average value of audio loudness of audio data sampled for a period of 60 seconds may be compared against a target audio loudness range. If the average value falls outside of the target audio loudness range, audio service 553 may adjust or update the live stream of audio data by changing (e.g., increasing or decreasing) an amplitude of a waveform of the real-time audio data. For example, an average value of an audio frequency of audio data recorded for a period of 90 seconds may be compared against a target audio frequency range. If the average value falls outside of the target audio frequency range, audio service 553 may adjust or update the live stream of audio data by filtering out waveforms of the real-time audio data that are out of the target audio frequency range. As a result, the adjusted or updated audio data may have a signal-to-noise ratio that is closer to the signal-to-noise ratio of the sampled audio data than a signal-to-noise ratio of the live stream of audio data that fail to satisfy the target criteria. Further, Audio service 553 may feed or otherwise provide the adjusted or updated audio data to the communication channel so that terminal 542 may receive the adjusted or updated audio data (e.g., Bob may hear Ann's voice clearly).

As shown with the arrow labeled as A, audio service 553 may be implemented by computing device 510. As shown with the arrow labeled as B, audio service 553 may be implemented by terminal 541 associated with the user who initiates a communication session with another user. As shown with the arrow labeled as C, audio service 553 may be implemented by terminal 542 associated with the other user who interacts with the user over the communication session. For example, audio service 553 may be used or integrated as a part of a virtual workspace (e.g., Citrix Workspace or other workspaces in cloud) or online communication applications (e.g., Microsoft Teams, Zoom, Webex, GoToMeeting, Skype, etc.).

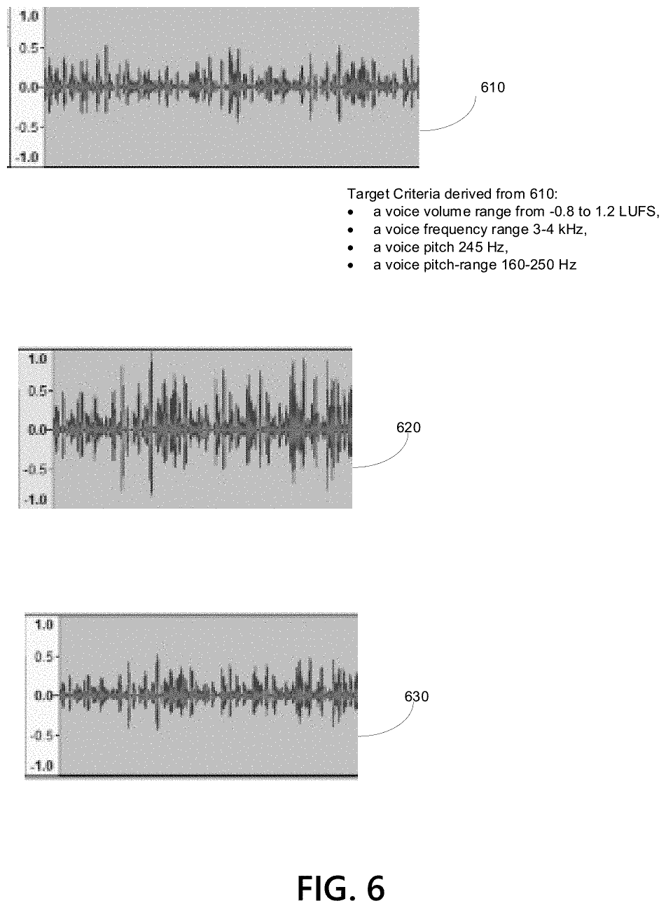

FIG. 6 shows an example of voice waveforms. The first voice waveform 610 (e.g., Ann's sampled or recorded voice) is an example of sampled audio data 551. Audio service 553 may extract one or more of audio characteristics of the sampled audio data and save the one or more into user profile 552. The extraction may involve measurements or calculations of the audio characteristics, for example, loudness, frequency, amplitude, pitch of audio data over a period of time (e.g., 10 seconds). Audio service 553 may determine the target criteria based on the extracted one or more of audio characteristics of the sampled audio data. For example, the target criteria may include a voice volume range (e.g., from −0.8 to 1.2 Loudness Unit Full Scale (LUFS)), a voice frequency range (e.g., 3-4 kHz), a voice pitch (e.g., 245 Hz), and/or a voice pitch-range (e.g., 160 to 250 Hz), etc.

The second voice waveform 620 (e.g., Ann's voice received by terminal 541) is an example of a live stream of audio data over an online communication application (e.g., Microsoft Teams). Audio service 553 may detect that one or more of audio characteristics of the live stream of audio data fail to satisfy the target criteria. For example, a voice volume and a voice frequency range of the live stream of audio data are out of the volume range and the voice frequency range of the target criteria respectively (e.g., Ann's voice may sound too loud and noisy for Bob to hear).

The third voice waveform 623 (e.g., Ann's voice received by terminal 542) is an example of adjusted or updated audio data. Audio service 553 may adjust or update the live stream of audio data so that the voice volume may fit within the volume range. For example, an amplitude of a waveform of the live stream of audio data may be increased or decreased. Audio service 553 may further adjust or update the live stream of audio data to satisfy the frequency range of the target criteria. For example, audio service 553 may detect signals that are out of the frequency range by comparing frequencies of the signals against a target frequency range, and filter out the detected signals to eliminate the background noise. Audio service 553 may feed the adjusted/updated audio data to the online communication application. Terminal 542 may receive the adjusted or updated audio data (e.g., Bob may hear Ann's voice with boosted audio quality).

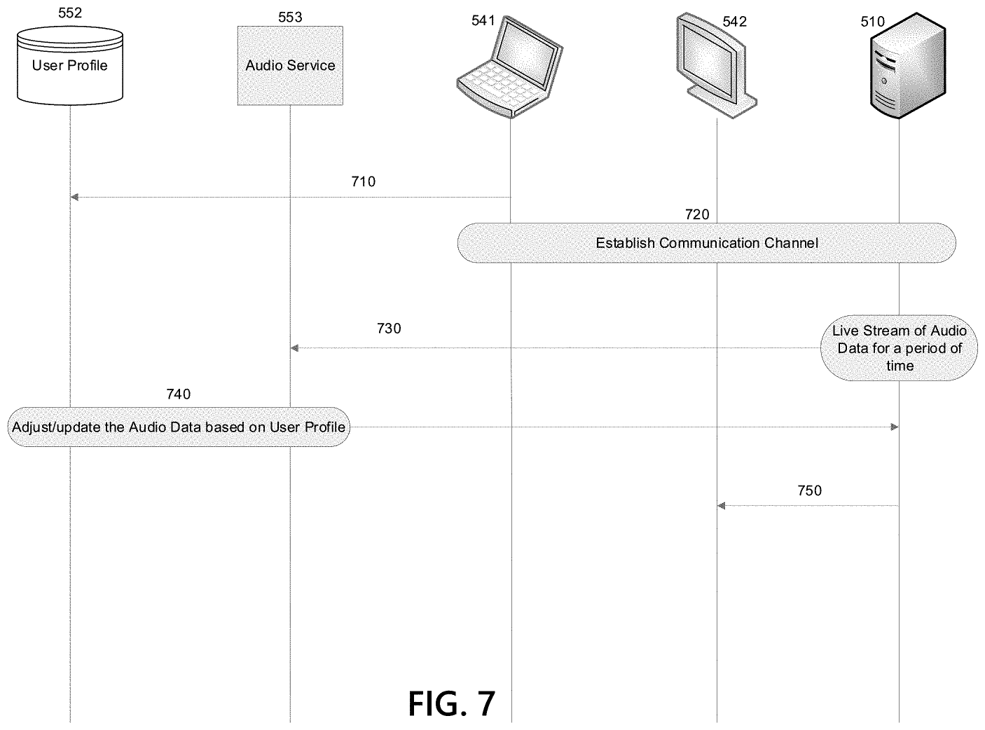

FIG. 7 shows an example of message sequences for audio service. At step 710, audio data may be sampled or recorded and saved into user profile 552. At step 720, terminal 541 may initiate to communicate with terminal 542 via computing device 510. At step 730, audio service 553 may receive or monitor a live stream of audio data from computing device 510 for a period of time. At step 740, audio service 553 may detect that the live stream of audio data fails to meet the target criteria based on user profile 552 (e.g., including various thresholds for different target criterion). Further, audio service 553 may dynamically adjust or update the live stream of audio data to satisfy the target criteria and provide the adjusted or updated live stream of audio data to computing device 510. For example, the adjustment or update may involve filtering out noises from the live stream of audio data or changing amplitudes of waveforms of the live stream of audio data. At step 750, computing device 510 forward the adjusted or updated live stream of audio data to terminal 542.

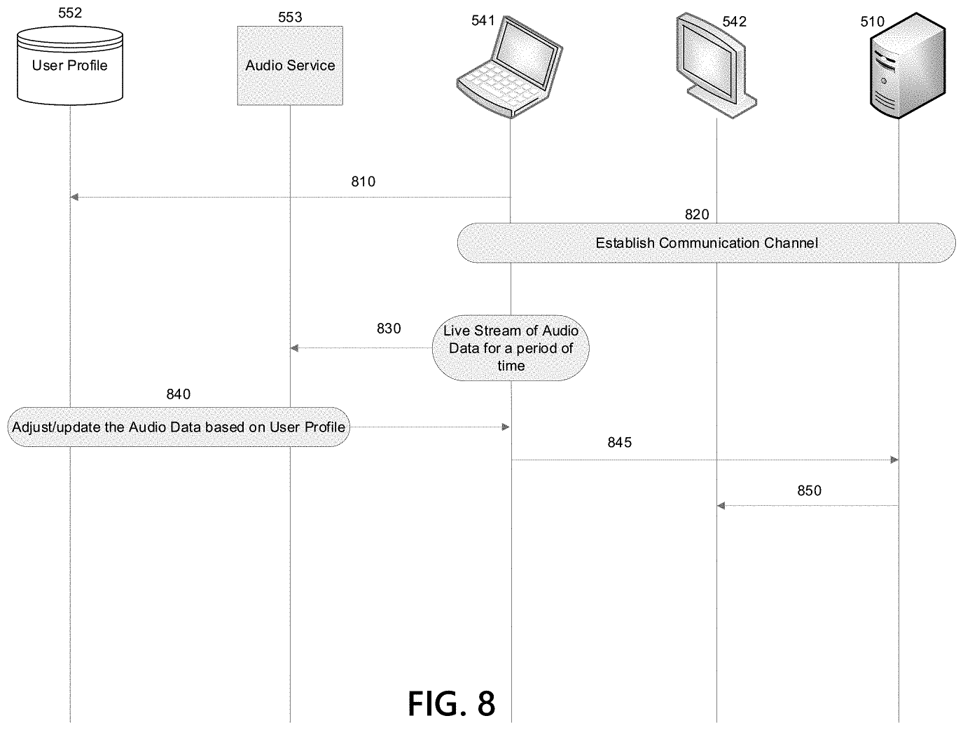

FIG. 8 shows an example of alternative message sequences for audio service. At step 810, audio data may be sampled or recorded and saved into user profile 552. At step 820, terminal 541 may initiate to communicate with terminal 542 via computing device 510. At step 830, audio service 553 may receive and monitor a live stream of audio data from terminal 541 for a period of time. At step 840, audio service 553 may detect that the live stream of audio data fails to meet the target criteria based on user profile 552. Further, audio service 553 may dynamically adjust or update the live stream of audio data to satisfy the target criteria and provide the adjusted or updated live stream of audio data to terminal 541. At step 845, terminal 541 forward the adjusted or updated live stream of audio data to computing device 510. At step 850, computing device 510 forward the adjusted or updated live stream of audio data to terminal 542.

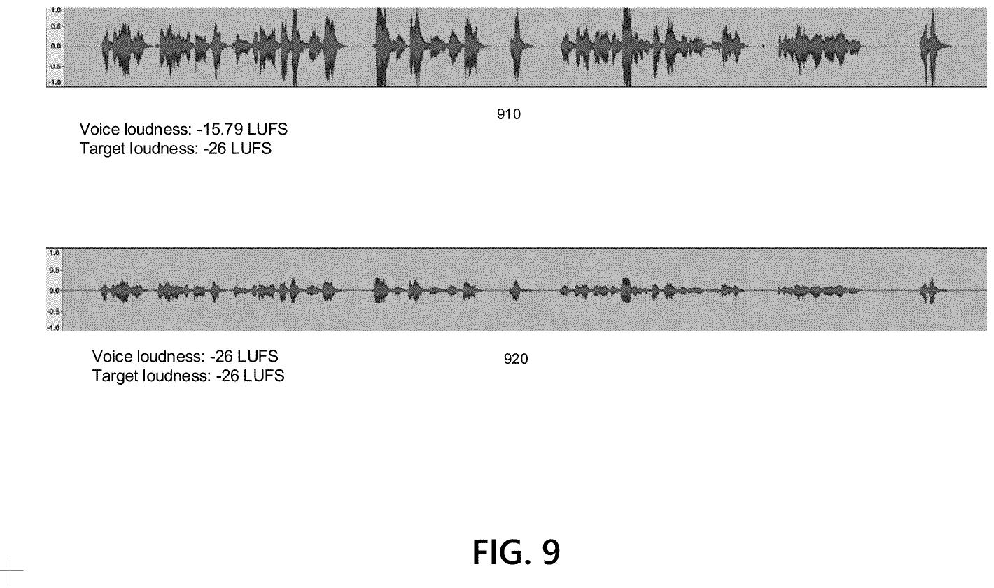

FIG. 9 shows an example of voice waveforms before and after audio service. The first voice waveform 910 may represent audio data (e.g., Ann's voice) in real-time communication before any adjustment by audio service 553. For example, the first voice waveform 910 may have loudness of −15.79 LUFS, which fails to meet, for example, the target loudness of −26 LUFS. The second voice waveform 920 may represent adjusted or updated live stream of audio data in real-time communication after audio service 553. The second voice waveform 920 may have loudness of −26 LUFS.

Audio service 553 may apply or use a volume filter to alter the volume of the live stream of audio data represented by the first voice waveform 910. Audio service 553 may specify parameters of the volume filter. For example, the parameters may include the target loudness, integrated loudness (e.g., average loudness over the entire period of time), true peak (e.g., the loudest point in signal), loudness range (LRA), loudness threshold, and/or loudness target offset, etc. The volume filter may change (e.g., dynamically change) an amplitude of the first voice waveform 910, for example, based on one or more of the specified parameters, to match a volume range of the first voice waveform 910 with the target loudness. As a result, the first voice waveform 910 is transformed to the second voice waveform 920.

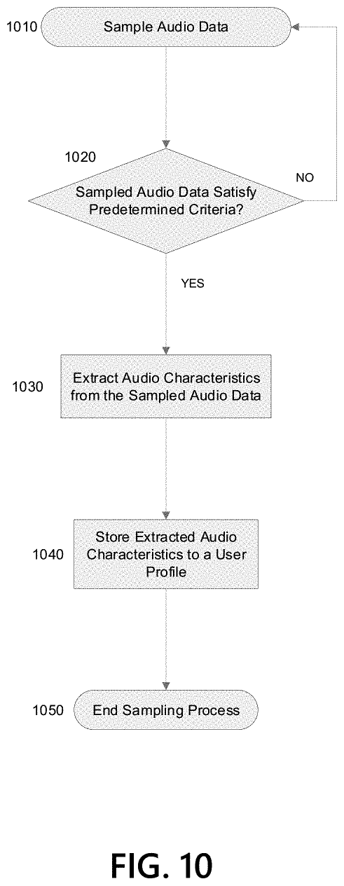

FIG. 10 shows an example of sampling audio data process. At step 1010, audio data may be recorded or sampled without a background noise or with a nominal amount of ambient noise. At step 1020, the sampled or recorded audio data may be evaluated if the sampled or recorded audio data meet criteria. The criteria may include, for example, a signal-to-noise ratio satisfying a first threshold level, a minimum volume range satisfying a second threshold level, a minimum length satisfying a third threshold level, etc.

At step 1030, if the criteria are not met, it goes back to step 1010. If the criteria are met, it proceeds to step 1030. At step 1030, audio characteristics from the sampled or recorded (e.g., for about 10-60 seconds) audio data are extracted. The extracted audio characteristics may include, for example, a volume range, a frequency range, a pitch, a pitch-range, etc. At step 1040, the extracted audio characteristics may be stored to a user profile, for example, in a workspace (e.g., Citrix Workspace) or in the cloud. At step 1050, sampling process is completed and the user profile is ready for audio service in real-time communications.

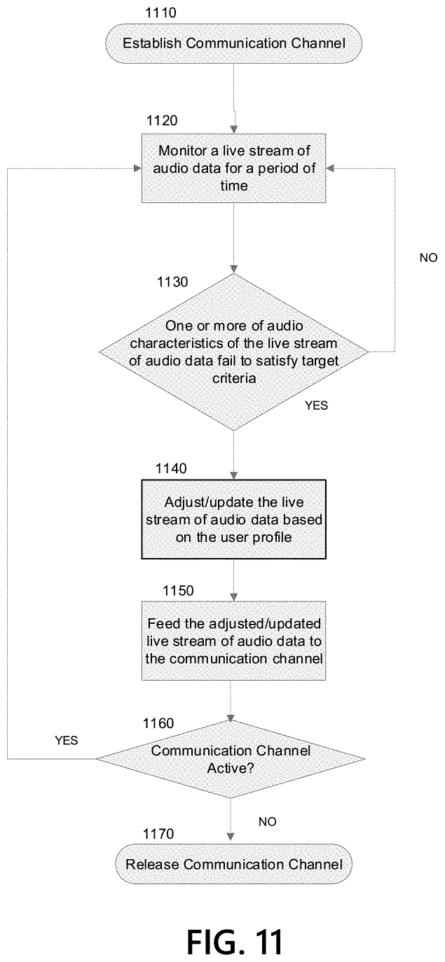

FIG. 11 shows an example of audio service process. The audio service may be dynamically provided in real-time communications. At step 1110, a communication channel may be established, for example, via an online communication application (e.g., Zoom). At step 1120, a live stream of audio data over the communication channel may be monitored for a period of time. The monitoring may involve measurements or calculations of, for example, average values of audio volumes or audio frequencies of audio data over the period of time. At step 1130, the audio service may determine whether one or more of audio characteristics of the live stream of audio data, monitored for the period of time, fail to satisfy target criteria. The determination may involve comparing the average values against corresponding threshold range values (e.g., comparing average value of audio volume against a target audio volume range). If not failed, it may go back to step 1120, and may monitor the live stream of audio data again for a next period of time. If failed, it may proceed to step 1140. At step 1140, the live stream of audio data may be adjusted or updated based on the user profile to satisfy the target criteria. At step 1150, the adjusted or updated live stream of audio data may be fed to the communication channel. Further, at step 1150, it may proceed to step 1160 to check if the communication channel is active. At step 1160, if it determines that the communication channel is active, it may proceed to go back to step 1120 to monitor again a next live stream of audio data for a next period of time. In this manner, the audio service may monitor repeatedly and dynamically intervene as needed whenever audio quality goes down for a period of time. The period of time may be set or re-set by a system administrator or a user. The shorter the period of time, the finer granularity of audio quality measurements may be performed while a processing load may increase. At step 1160, if it determines that the communication channel is no longer active, it may proceed to step 1170. At step 1170, the communication channel may be released as no longer needed (e.g., a video or an audio conference is terminated).

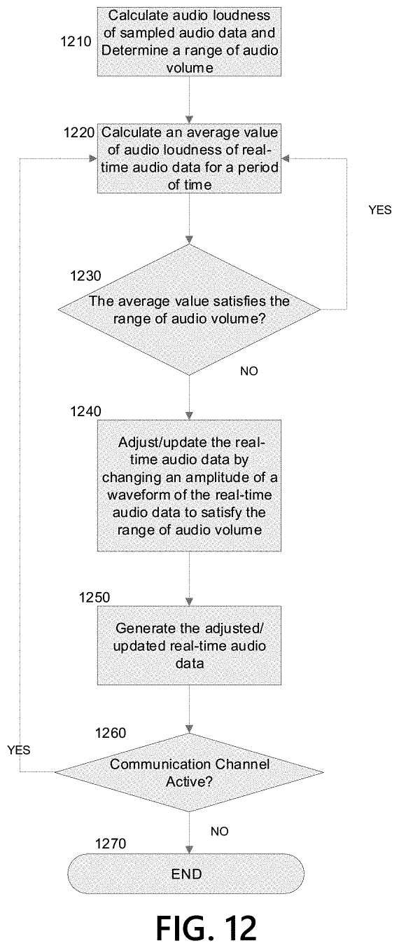

FIG. 12 shows an example of adjusting or updating process. At step 1210, audio loudness of sampled or recorded audio data may be calculated or measured and a range of audio volume may be determined based on the measured audio loudness. The determination may involve measurements or calculations of magnitudes of amplitudes of waveforms of audio data. At step 1220, a value (e.g., an average value of audio loudness) of real-time audio data (e.g. a live stream of audio data) monitored for a period of time may be calculated. At step 1230, it may determine whether the average value satisfies the range of audio volume. If satisfied, it may go back to step 1220 and calculate a next value for a next period of time. If not satisfied, it may proceed to step 1240. At step 1240, the real-time audio data may be adjusted or updated by changing an amplitude of a waveform of the real-time audio data to satisfy the range of audio volume. At step 1250, the adjusted or updated real-time audio data may be generated and fed into a communication channel or an online communication application (e.g., Skype). Further, at step 1260, it may check if the communication channel is active, and if active, may go back to step 1220 to monitor again for a next period of time. At step 1260, if the communication channel is no longer active, it may proceed to end the adjusting or updating process at step 1270.

The features described herein is advantageous in that a user, who may not even aware of poor audio quality in real-time communication from the user's end, may be assured that other user may receive the user's audio data with enhanced or acceptable audio quality. The features may be integrated into the user's terminal, other user's terminal, a virtual workspace or the cloud, or an online communication application to mitigate a background noise or a poor network condition impacting the audio quality.

The following paragraphs (M1) through (M10) describe examples of methods that may be implemented in accordance with the present disclosure.

(M1) A method comprising receiving, by a computing device, first and second data from a first endpoint device, the first and second data being audible input from a same user, the first data satisfies a threshold indicative of a level of quality in output of audio data by a second endpoint device, and the second data being input for a computing session between the first endpoint device and a plurality of devices including the second endpoint device, comparing, by the computing device, the first and second data to one another to determine whether the second data satisfies the threshold, responsive to a failure of the second data to meet the threshold, modifying, by the computing device, the second data, and providing, by the computing device, the modified second data to the second endpoint device of the plurality of devices, wherein the second endpoint device outputs the modified second data at the level of quality for the computing session.

(M2) A method may be performed as described in paragraph (M1) wherein the level of quality indicates that a first signal-to-noise ratio of the first data is greater than a second signal-to-noise ratio of the second data, a third signal-to-noise ratio of the modified second data is closer to the first signal-to-noise ratio than the second signal-to-noise ratio.

(M3) A method of may be performed as described in any of paragraphs (M1) through (M2) further comprising calculating an average value of one of audio characteristics of the second data for a period of time that the second data is monitored, and determining whether the average value satisfies the threshold.

(M4) A method may be performed as described in any of paragraphs (M1) through (M3) further comprising extracting at least one of a volume range, a bandwidth, a pitch, and a pitch-range from the audio characteristics of the first data.

(M5) A method may be performed as described in any of paragraphs (M1) through (M4) wherein the modifying the second data comprises changing at least one of a volume range, a bandwidth, a pitch, and a pitch-range of the second data.

(M6) A method of may be performed as described in any of paragraphs (M1) through (M5) wherein the modifying the second data comprises changing an amplitude of a waveform of the second data to match a volume range of the second data with a volume range of the first data.

(M7) A method may be performed as described in any of paragraphs (M1) through (M6) wherein the modifying the second data comprises comparing at least one of a volume range, a bandwidth, a pitch, and/or a pitch-range of the second data against the at least one of the first data.

(M8) A method may be performed as described in any of paragraphs (M1) through (M7) wherein the computing device is a server that is providing an online communication application, the computing device sends the modified second data in real-time to the second endpoint device.

(M9) A method may be performed as described in any of paragraphs (M1) through (M8) wherein a first voice in the first data and a second voice in the second data are from a same source.

(M10) A method may be performed as described in any of paragraphs (M1) through (M9) further comprising saving the first data as part of a client profile in a workspace or in a cloud storage.

The following paragraphs (S1) through (S5) describe examples of a system that may be implemented in accordance with the present disclosure.

(S1) A system comprising a processor, and a memory storing computer readable instructions that, when executed by the processor, cause the system to receive, by a computing device, first and second data from a first endpoint device, the first and second data being audible input from a same user, the first data satisfies a threshold indicative of a level of quality in output of audio data by a second endpoint device, and the second data being input for a computing session between the first endpoint device and a plurality of devices including the second endpoint device, compare, by the computing device, the first and second data to one another to determine whether the second data satisfies the threshold, responsive to a failure of the second data to meet the threshold, modify, by the computing device, the second data, and provide, by the computing device, the modified second data to the second endpoint device of the plurality of devices, wherein the second endpoint device outputs the modified second data at the level of quality for the computing session.

(S2) A system may be performed as described in paragraph (S2) wherein the level of quality indicates that a first signal-to-noise ratio of the first data is greater than a second signal-to-noise ratio of the second data, a third signal-to-noise ratio of the modified second data is closer to the first signal-to-noise ratio than the second signal-to-noise ratio.

(S3) A system may be performed as described in any of paragraphs (S1) through (S2) wherein the computer readable instructions, when executed by the processor, further cause the system to calculate an average value of one of audio characteristics of the second data for a period of time that the second data is monitored, and determine whether the average value satisfies the threshold.

(S4) A system may be performed as described in any of paragraphs (S1) through (S3) wherein the computer readable instructions, when executed by the processor, further cause the system to change an amplitude of a waveform of the second data to match a volume range of the second data with a volume range of the first data.

(S5) A system may be performed as described in any of paragraphs (S1) through (S4) wherein the computer readable instructions, when executed by the processor, further cause the system to compare at least one of a volume range, a bandwidth, a pitch, and/or a pitch-range of the second data against the at least one of the first data.

The following paragraphs (CRM1) through (CRM5) describe examples of computer-readable medium that may be implemented in accordance with the present disclosure.

(CRM1) A non-transitory computer readable medium storing computer readable instructions thereon that, when executed by a processor, causes the processor to perform a method comprising receiving, by a computing device, first and second data from a first endpoint device, the first and second data being audible input from a same user, the first data satisfies a threshold indicative of a level of quality in output of audio data by a second endpoint device, and the second data being input for a computing session between the first endpoint device and a plurality of devices including the second endpoint device, comparing, by the computing device, the first and second data to one another to determine whether the second data satisfies the threshold, responsive to a failure of the second data to meet the threshold, modifying, by the computing device, the second data, and providing, by the computing device, the modified second data to the second endpoint device of the plurality of devices, wherein the second endpoint device outputs the modified second data at the level of quality for the computing session.

(CRM2) A non-transitory computer readable medium of paragraph (CRM1) wherein the level of quality indicates that a first signal-to-noise ratio of the first data is greater than a second signal-to-noise ratio of the second data, a third signal-to-noise ratio of the modified second data is closer to the first signal-to-noise ratio than the second signal-to-noise ratio.

(CRM3) A non-transitory computer readable medium of any one of paragraphs (CRM1) through (CRM 2) wherein the computer readable instructions, when executed by the computer, further cause the computer to perform the method further comprising calculating an average value of one of audio characteristics of the second data for a period of time that the second data is monitored, and determining whether the average value satisfies the threshold.

(CRM4) A non-transitory computer readable medium of any one of paragraphs (CRM1) through (CRM 3) wherein the modifying the second data comprises changing an amplitude of a waveform of the second data to match a volume range of the second data with a volume range of the first data.

(CRM5) A non-transitory computer readable medium of any one of paragraphs (CRM1) through (CRM 4) wherein the modifying the second data comprises comparing at least one of a volume range, a bandwidth, a pitch, and/or a pitch-range of the second data against the at least one of the first data.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. A method comprising:
receiving, by a computing device, first and second data from a first endpoint device, the first and second data being audible input from a same user, the first data satisfies a threshold indicative of a level of quality in output of audio data by a second endpoint device, and the second data being input for a computing session between the first endpoint device and a plurality of devices including the second endpoint device;
comparing, by the computing device, the first and second data to one another to determine whether the second data satisfies the threshold;
responsive to a failure of the second data to meet the threshold, modifying, by the computing device, the second data; and
providing, by the computing device, the modified second data to the second endpoint device of the plurality of devices, wherein the second endpoint device outputs the modified second data at the level of quality for the computing session.

2. The method of claim 1, wherein the level of quality indicates that a first signal-to-noise ratio of the first data is greater than a second signal-to-noise ratio of the second data, a third signal-to-noise ratio of the modified second data is closer to the first signal-to-noise ratio than the second signal-to-noise ratio.

3. The method of claim 1, further comprising:
calculating an average value of one of audio characteristics of the second data for a period of time that the second data is monitored; and
determining whether the average value satisfies the threshold.

4. The method of claim 1, further comprising:
extracting at least one of a volume range, a bandwidth, a pitch, and a pitch-range from the audio characteristics of the first data.

5. The method of claim 1, wherein the modifying the second data comprises changing at least one of a volume range, a bandwidth, a pitch, and a pitch-range of the second data.

6. The method of claim 1, wherein the modifying the second data comprises changing an amplitude of a waveform of the second data to match a volume range of the second data with a volume range of the first data.

7. The method of claim 1, wherein the modifying the second data comprises comparing at least one of a volume range, a bandwidth, a pitch, and/or a pitch-range of the second data against the at least one of the first data.

8. The method of claim 1, wherein the computing device is a server that is providing an online communication application, the computing device sends the modified second data in real-time to the second endpoint device.

9. The method of claim 1, wherein a first voice in the first data and a second voice in the second data are from a same source.

10. The method of claim 1, further comprising:
saving the first data as part of a client profile in a workspace or in a cloud storage.

11. A system comprising:
a processor; and
a memory storing computer readable instructions that, when executed by the processor, cause the system to:
receive, by a computing device, first and second data from a first endpoint device, the first and second data being audible input from a same user, the first data satisfies a threshold indicative of a level of quality in output of audio data by a second endpoint device, and the second data being input for a computing session between the first endpoint device and a plurality of devices including the second endpoint device;
compare, by the computing device, the first and second data to one another to determine whether the second data satisfies the threshold;
responsive to a failure of the second data to meet the threshold, modify, by the computing device, the second data; and
provide, by the computing device, the modified second data to the second endpoint device of the plurality of devices, wherein the second endpoint device outputs the modified second data at the level of quality for the computing session.

12. The system of claim 11, wherein the level of quality indicates that a first signal-to-noise ratio of the first data is greater than a second signal-to-noise ratio of the second data, a third signal-to-noise ratio of the modified second data is closer to the first signal-to-noise ratio than the second signal-to-noise ratio.

13. The system of claim 11, wherein the computer readable instructions, when executed by the processor, further cause the system to:
calculate an average value of one of audio characteristics of the second data for a period of time that the second data is monitored; and
determine whether the average value satisfies the threshold.

14. The system of claim 11, wherein the computer readable instructions, when executed by the processor, further cause the system to:
change an amplitude of a waveform of the second data to match a volume range of the second data with a volume range of the first data.

15. The system of claim 11, wherein the computer readable instructions, when executed by the processor, further cause the system to:
compare at least one of a volume range, a bandwidth, a pitch, and/or a pitch-range of the second data against the at least one of the first data.

16. A non-transitory computer readable medium storing computer readable instructions thereon that, when executed by a processor, causes the processor to perform a method comprising:
receiving, by a computing device, first and second data from a first endpoint device, the first and second data being audible input from a same user, the first data satisfies a threshold indicative of a level of quality in output of audio data by a second endpoint device, and the second data being input for a computing session between the first endpoint device and a plurality of devices including the second endpoint device;
comparing, by the computing device, the first and second data to one another to determine whether the second data satisfies the threshold;
responsive to a failure of the second data to meet the threshold, modifying, by the computing device, the second data; and
providing, by the computing device, the modified second data to the second endpoint device of the plurality of devices, wherein the second endpoint device outputs the modified second data at the level of quality for the computing session.

17. The non-transitory computer readable medium of claim 16, wherein the level of quality indicates that a first signal-to-noise ratio of the first data is greater than a second signal-to-noise ratio of the second data, a third signal-to-noise ratio of the modified second data is closer to the first signal-to-noise ratio than the second signal-to-noise ratio.

18. The non-transitory computer readable medium of claim 16, wherein the computer readable instructions, when executed by the computer, further cause the computer to perform the method further comprising:
calculating an average value of one of audio characteristics of the second data for a period of time that the second data is monitored; and
determining whether the average value satisfies the threshold.

19. The non-transitory computer readable medium of claim 16, wherein the modifying the second data comprises changing an amplitude of a waveform of the second data to match a volume range of the second data with a volume range of the first data.

20. The non-transitory computer readable medium of claim 16, wherein the modifying the second data comprises comparing at least one of a volume range, a bandwidth, a pitch, and/or a pitch-range of the second data against the at least one of the first data.
